(19) United States
(12) Patent Application Publication
(10) Pub. No.: US 2026/0287921 A1
(43) Pub. Date: Sep. 24, 2026

(54) FLOATING IMAGE DISPLAY DEVICE

(71) Applicant: Mitsubishi Electric Corporation, Tokyo (JP)

(72) Inventor: Hayato KIKUTA, Tokyo (JP)

(73) Assignee: Mitsubishi Electric Corporation, Tokyo (JP)

(21) Appl. No.: 18/716,514

(22) PCT Filed: Dec. 15, 2021
(86) PCT No.: PCT/JP2021/046247

§ 371 Date: Jun. 4, 2026

(51) Int. Cl. G02B 30/56

(52) U.S. Cl. CPC G02B 30/56

(57) ABSTRACT

A floating image display device includes an image display unit that displays an image, a retroreflective member, and an optical member. The retroreflective member includes a plurality of apertures through which image light emitted from the image display unit passes and a plurality of retroreflecting surfaces. The optical member includes a light splitting surface reflecting and passing incident light, reflects the image light after passing through the plurality of apertures, and directs the image light toward the plurality of retroreflecting surfaces. The image light retroreflected by the plurality of retroreflecting surfaces passes through the optical member, and directions of the plurality of retroreflecting surfaces differ from each other.

### TECHNICAL FIELD

The present disclosure relates to a floating image display device.

### BACKGROUND ART

There has been proposed a floating image display device that displays a floating image obtained by reimaging image light emitted from an image display unit in space by using an image formation optical system formed by combining a retroreflective member and a beam splitter (see Patent Reference 1 and Non-patent Reference 1, for example).

In the floating image display device of the Patent Reference 1, stray light (specifically, specularly reflected light) other than the image light for forming an image as the floating image is prevented from being visually recognized by an observer by arrangement design of the image formation optical system. In the floating image display device of the Non-patent Reference 1, the retroreflective member is provided with apertures like slits or a lattice, and the retroreflective member and the beam splitter are arranged in a stack, by which enlargement of the size of the device is prevented.

### PRIOR ARI REFERENCE

### Patent Reference

Patent Reference 1; Japanese Patent No. 6,638,450

### Nonpatent Reference

Non-patent Reference 1:“Aerial Display by Use of a Full-color LED Panel Covered with Apertured Retro-reflector”, 2020

### SUMMARY OF THE INVENTION

### Problem to be Solved by the Invention

However, in floating image display devices including the retroreflective member including apertures as in the Non-patent Reference 1, there is a problem in that stray light different from the specularly reflected light described in the Patent Reference 1 occurs. Specifically, in the Non-patent Reference 1, the stray light is caused also by the structure of an optical element in the retroreflective member. Further, the stray light occurs also when the image light passes through the apertures. When such stray light travels in an optical path for forming the floating image, the observer's visibility of the floating image deteriorates remarkably.

An object of the present disclosure is to provide a floating image display device capable of inhibiting the deterioration of the visibility of the floating image.

### Means for Solving the Problem

A floating image display device according to an aspect of the present disclosure includes an image display unit that displays an image, a retroreflective member including a plurality of apertures through which image light emitted from the image display unit passes and a plurality of retroreflecting surfaces, and an optical member including a light splitting surface reflecting and passing incident light. The optical member reflects the image light after passing through the plurality of apertures and directs the image light toward the plurality of retroreflecting surfaces. The image light retroreflected by the plurality of retroreflecting surfaces passes through the optical member, and directions of the plurality of retroreflecting surfaces differ from each other.

A floating image display device according to another aspect of the present disclosure includes an image display unit that displays an image, a first retroreflective member including a plurality of first apertures through which image light emitted from the image display unit passes and a single or plurality of first retroreflecting surfaces, and an optical member including a light splitting surface reflecting and passing incident light.

The optical member reflects the image light after passing through the plurality of first apertures and directs the image light toward the single or plurality of first retroreflecting surfaces. The image light retroreflected by the single or plurality of first retroreflecting surfaces passes through the optical member, and widths of the plurality of first apertures differ from each other.

### Effect of the Invention

According to the present disclosure, the deterioration of the visibility of the floating image can be inhibited.

### BRIEF DESCRIPTION OF THE DRAWINGS

FIG. 1 is a configuration diagram schematically showing an example of the configuration of a floating image display device according to a first embodiment.

FIG. 2 is a perspective view schematically showing an example of the configuration of a retroreflective member shown in FIG. 1.

FIG. 3 is an explanatory drawing for explaining a comparison between the size of a housing of the floating image display device according to the first embodiment and the size of a housing of a floating image display device according to a comparative example.

FIG. 4 is an explanatory drawing for explaining a configuration in which directions of a plurality of retroreflecting surfaces shown in FIG. 1 differ from each other.

FIG. 5 is a configuration diagram schematically showing an example of the configuration of a floating image display device according to a modification of the first embodiment,

FIG. 6 is a block diagram showing the configuration of the floating image display device according to the modification of the first embodiment.

FIG. 7 (A) is a block diagram schematically showing an example of the hardware configuration of a control unit of the floating image display device according to the modification of the first embodiment. (B) is a diagram schematically showing another example of the hardware configuration of the control unit of the floating image display device according to the modification of the first embodiment.

FIG. 8 is an explanatory drawing for explaining an example of control of the plurality of retroreflecting surfaces in the floating image display device according to the modification of the first embodiment.

FIG. 9 is an explanatory drawing for explaining another example of the control of the plurality of retroreflecting surfaces in the floating image display device according to the modification of the first embodiment.

FIG. 10 is a configuration diagram schematically showing an example of the configuration of a floating image display device according to a second embodiment.

FIG. 11 is a configuration diagram schematically showing an example of the configuration of a floating image display device according to a first modification of the second embodiment.

FIG. 12 is a configuration diagram schematically showing an example of the configuration of a floating image display device according to a second modification of the second embodiment.

FIG. 13 is a perspective view showing the configuration of a retroreflective member of a floating image display device according to a third embodiment.

FIG. 14 is a perspective view showing the configuration of a retroreflective member of a floating image display device according to a modification of the third embodiment.

FIG. 15 is a perspective view showing another example of the configuration of the retroreflective member of the floating image display device according to the modification of the third embodiment.

### MODE FOR CARRYING OUT THE INVENTION

Floating image display devices according to embodiments of the present disclosure will be described below with reference to the drawings. The following embodiments are just examples and it is possible to appropriately combine embodiments and appropriately modify each embodiment.

Coordinate axes of an XYZ orthogonal coordinate system are shown in some of the drawings in order to facilitate the understanding of the description. An X-axis is a coordinate axis representing an axis in a width direction of the floating image display device. A Y-axis is a coordinate axis representing an axis in a depth direction of the floating image display device. A Z-axis is a coordinate axis representing an axis in an up-down direction of the floating image display device. Further, in the following description, “top”, “bottom”, “front” and “back”, respectively mean top, bottom, front and back when the floating image display device is viewed from the front. It should be noted that “top”, “bottom”, “front” and “back” are terms indicating directions used to facilitate the understanding of explanation of each part. The definition of these directions does not limit the shapes, positions and so forth of members forming the floating image display device according to each embodiment of the present disclosure.

### First Embodiment

### Configuration of Floating Image Display Device 100

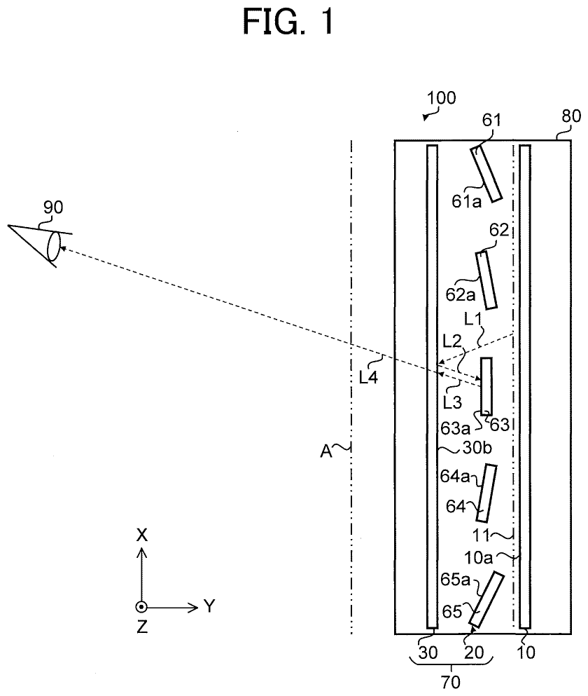

FIG. 1 is a configuration diagram schematically showing an example of the configuration of a floating image display device 100 according to a first embodiment. As shown in FIG. 1, the floating image display device 100 includes an image display unit 10, a retroreflective member 20, a beam splitter 30 as an optical member, and a housing 80. The housing 80 houses the image display unit 10, the retroreflective member 20 and the beam splitter 30. In the following, a description will be given of the configuration of each of the image display unit 10, the retroreflective member 20 and the beam splitter 30 and an optical path of light for forming a floating image A displayed by the floating image display device 100.

The image display unit 10 is a display device that displays an image 11 accompanied by emission of light. The image display unit 10 emits image light L1. The image light L1 is diffuse light. The image display unit 10 is, for example, a display device having a two-dimensional flat surface light source. The image display unit 10 is, for example, a display device including a liquid crystal display (liquid crystal element) and a backlight. The image display unit 10 can also be a display device including a self-luminous element such as an organic EL (Electroluminescence) element or an LED (Light Emitting Diode) element, or a projection device including a projector and a screen.

The image display unit 10 is not limited to a display device having a two-dimensional flat surface light source but can also be a display having a curved surface, a display arranged three-dimensionally, a stereoscopic display including LEDS, or the like. Further, the image display unit 10 can also be a display that includes a lens optical system and a barrier control unit and thereby makes use of stereoscopic vision due to binocular parallax or kinematic parallax of the observer 90.

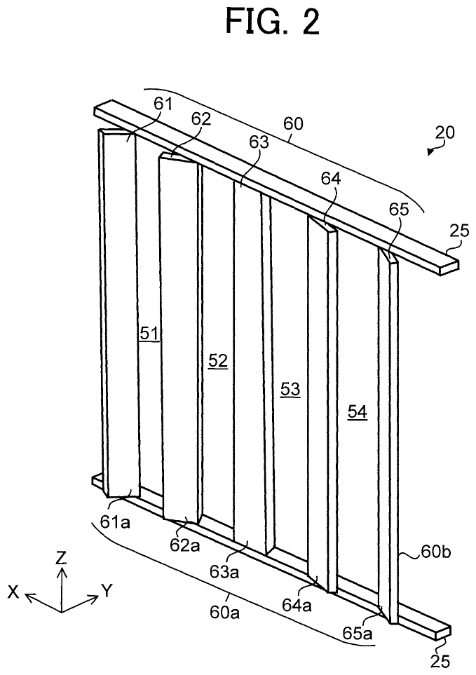

FIG. 2 is a perspective view schematically showing an example of the configuration of the retroreflective member 20 shown in FIG. 1. As shown in FIGS. 1 and 2, the retroreflective member 20 includes a plurality of apertures 51, 52, 53 and 54 and a plurality of retroreflective elements 61, 62, 6 63, 64 and 65.

The plurality of apertures 51 to 54 and the plurality of retroreflective elements 61 to 65 are arrayed alternately in an X-axis direction (first direction) as an array direction. The plurality of retroreflective elements 61 to 65 face the beam splitter 30 in a Y-axis direction (second direction) orthogonal to the array direction of the plurality of apertures 51 to 54.

The image light L1 emitted from the image display unit 10 passes through the plurality of apertures 51 to 54. In the example shown in FIG. 2, the shape of each of the plurality of apertures 51 to 54 is a slit-like shape being long in a Z-axis direction (third direction). It should be noted that, in the following description, the plurality of apertures 51 to 54 are also collectively referred to as “the plurality of apertures 50” when it is unnecessary to distinguish among the plurality of apertures 51 to 54.

The plurality of retroreflective elements 61 to 65 retroreflect light incident thereon. The plurality of retroreflective elements 61 to 65 respectively have a plurality of retroreflecting surfaces 61a to 65a. The plurality of retroreflecting surfaces 61a to 65a are arranged at positions facing a light splitting surface 30b of the beam splitter 30, which will be described later, in the Y-axis direction. It should be noted that, in the following description, the plurality of retroreflective elements 61 to 65 are also collectively referred to as “the plurality of retroreflective elements 60” when it is unnecessary to distinguish among the plurality of retroreflective elements 61 to 65. Further, the plurality of retroreflecting surfaces 61a to 65a are also collectively referred to as “the plurality of retroreflecting surfaces 60a” when it is unnecessary to distinguish among the plurality of retroreflecting surfaces 61a to 65a.

The retroreflective element 60 has a retroreflection function of reflecting the incident light towards the incidence direction of the incident light. The retroreflective element 60 is a sheet-like optical element. The retroreflective element 60 is a retroreflective sheet of the so-called bead type, for example. In the retroreflective sheet of the bead type, a plurality of minute glass beads have been encapsulated, and each glass bead has a spherical mirror surface. The retroreflective sheet of the bead type refracts the incident light with the spherical mirror surfaces and reflects the light with base parts of the beads. The light reflected by the base part of the bead is refracted again by the mirror surface. By this process, the retroreflective sheet of the bead type emits retroreflected light. It should be noted that the retroreflective element 60 can also be a retroreflective sheet of the so-called prism type. On the retroreflective sheet of the prism type, a plurality of minute microprisms are arrayed, and each microprism has mirror surfaces. The microprism is, for example, a triangular pyramid prism in a convex shape or a hollow triangular pyramid prism. The retroreflective sheet of the prism type reflects the incident light multiple times with internal mirror surfaces of the triangular pyramid prism and thereby emits the retroreflected light.

The retroreflective member 20 further includes support parts 25 supporting end parts of the plurality of retroreflective elements 60 on both sides in the Z-axis direction.

Next, returning to FIG. 1, the configuration of the beam splitter 30 will be described below. The beam splitter 30 reflects the image light L1 emitted from the image display unit 10. The beam splitter 30 has a light splitting function of splitting the incident light into reflected light and transmitted light. The beam splitter 30 has the light splitting surface 30b that reflects and passes the incident image light L1. The light splitting surface 30b faces the retroreflective member 20. The light splitting surface 30b reflects the image light L1 after passing through the plurality of first apertures 51 to 54 and thereby directs the image light L1 toward the plurality of retroreflecting surfaces 60a.

The beam splitter 30 is formed from a transparent plate made of resin (e.g., acrylic plate) or a glass plate, for example. In the case of the transparent plate made of resin, the intensity of the transmitted light is generally higher than the intensity of the reflected light. Thus, in the case where the beam splitter 30 is formed from the transparent plate made of resin, the reflection intensity may be increased by adding a metallic membrane to the transparent plate. In this case, the beam splitter 30 is a half mirror, for example. The beam splitter 30 can also be, for example, a reflective polarizing plate that passes or reflects light incident from a liquid crystal element or a thin-film element depending on the polarization state of the incident light. Further, the beam splitter 30 can also be a reflective polarizing plate whose ratio between the transmittance and the reflectance changes depending on the polarization state of the incident light.

Next, a principle that the image light L1 forms an image as the floating image A in the space in which the observer 90 exists will be explained below with reference to FIG. 1. In the first embodiment, the image light L1 of the image 11 displayed on a display surface 10a of the image display unit 10 is made to form an image as the floating image A by an image formation optical system 70 formed with the image display unit 10, the beam splitter 30 and the retroreflective member 20. Specifically, the image light L1 incident upon the beam splitter 30 from the image display unit 10 is split into the reflected light (namely, light 12) and the transmitted light (not shown). The retroreflecting surface (retroreflecting surface 63a in FIG. 1) retroreflects the light L2 incident thereon and emits the retroreflected light as light 13. The light L3 is incident upon the beam splitter 30. The beam splitter 30 allows the light L3 to pass through it and emits the light L3 as light L4 heading for the eyes of the observer 90. By this process, the light L4 forms an image in the air where there is no display element.

As above, part of the image light L1 emitted from the image display unit 10 travels in an optical path of being reflected by the light splitting surface 30b of the beam splitter 30, thereafter retroreflected by the retroreflecting surface 63a, and thereby passing through the beam splitter 30. Here, the image light L1 is diffuse light as mentioned earlier. Thus, the image light L1 emitted from the image display unit 10 reconverges at a position that is plane-symmetrical with reference to the beam splitter 30. The reconverged light L4 diffuses again from the convergence position and enters the eyes of the observer 90. Accordingly, the floating image A based on the image 11 is displayed and thus the observer 90 can view the floating image A.

It should be noted that a back surface 60b (i.e., rear surface facing the image display unit 10) of the retroreflective element 60 shown in FIG. 2 may be provided with a lusterless surface coating or an optical treatment. By this, it is possible to prevent occurrence of light traveling in an optical path different from the optical path for forming the floating image A due to reflection of light on the back surface 60b of the retroreflective element 60.

### Downsizing of Housing 80

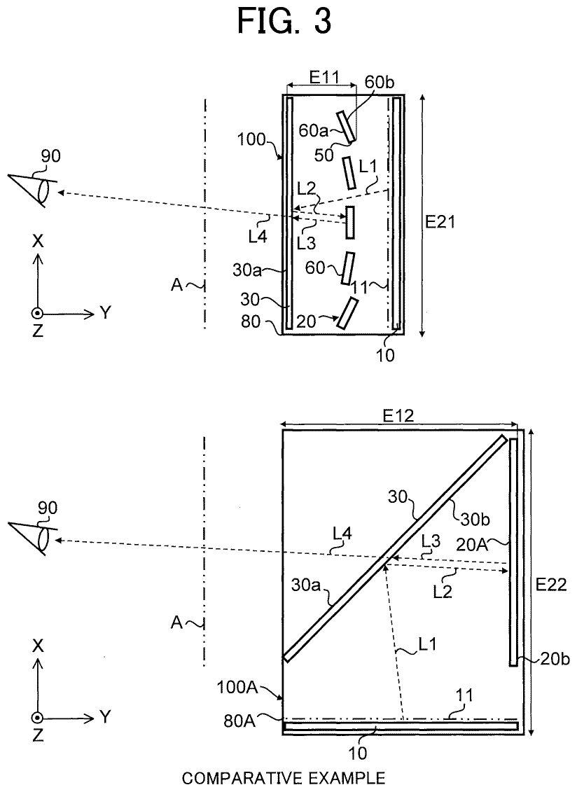

Next, an effect achieved by the retroreflective member 20 having a plurality of apertures 50 will be described below while making a comparison with a comparative example. FIG. 3 is an explanatory drawing for explaining the comparison between the size of the housing 80 of the floating image display device 100 according to the first embodiment and the size of a housing 80A of a floating image display device 100A according to the comparative example. The floating image display device 100A according to the comparative example includes the image display unit 10, a retroreflective member 20A, the beam splitter 30 and the housing 80A. The retroreflective member 20A in the comparative example differs from the retroreflective member 20 in the first embodiment in not including a plurality of apertures 50.

In general, the floating image A can be formed by a configuration in which an optical path until the image light is incident upon the beam splitter and an optical path until the reflected light reflected by the beam splitter is incident upon the retroreflective member differ from each other. Thus, in the floating image display device 100A according to the comparative example, the image formation of the floating image A is realized by arranging the image display unit 10 and the retroreflective member 20 at positions spatially separate from each other. However, the floating image display device 100A according to the comparative example has a problem in that the housing 80A increases in size.

Here, a dimension from a front surface 30a of the beam splitter 30 to the back surface 60b of the retroreflective element 60 is defined as a depth dimension E11, and a dimension from the front surface 30a of the beam splitter 30 to a back surface 20b of the retroreflective member 20A is defined as a depth dimension E12. Further, dimensions of the housings 80 and 80A in the up-down direction are assumed to be E21 and E22. The depth dimension E12 of the floating image display device 100A according to the comparative example is approximately twice the depth dimension E11 of the floating image display device 100. Further, in the floating image display device 100A according to the comparative example, the image display unit 10 is arranged under the beam splitter 30 as viewed from the observer 90. Therefore, the dimension E22 in the up-down direction of the housing 80A in the comparative example becomes greater than the dimension E21 in the up-down direction of the housing 80 in the first embodiment. The dimension E22 in the up-down direction of the housing 80A is approximately 1.2 times the direction dimension E21 in the up-down direction of the housing 80, for example. As above, the housing 80A increases in size when the retroreflective member 20 does not include a plurality of apertures 50.

In contrast, in the first embodiment, the retroreflective member 20 includes a plurality of apertures 50 through which the image light L1 passes and a plurality of retroreflecting surfaces 60a arranged at positions facing the light splitting surface 30b. With this configuration, the image light L1 can be made to be incident upon the beam splitter 30 via the apertures 50. Accordingly, in comparison with the floating image display device 100A according to the comparative example, the floating image display device 100 according to the first embodiment is capable of forming the floating image A while downsizing the housing 80.

### Stray Light

Next, the deterioration of the visibility of the floating image A due to the stray light will be explained below with reference to FIG. 1. In the first embodiment, the optical path of the light for forming the floating image A includes an optical path of the image light L1 that has passed through the aforementioned plurality of apertures 50, and thus the observer 90 can view the floating image A corresponding to the shape of the aperture 50. However, in the floating image display device 100, there exists light called “stray light” traveling in an optical path different from the optical path for forming the floating image A. The stray light deteriorates the visibility of the floating image A.

The stray light is caused by specular reflection at the retroreflective element 60, for example. Specifically, there is a case where part of the light 12 incident upon the retroreflective element 60 undergoes specular reflection due to a surface treatment on the retroreflective element 60. As above, there is a case where the image light L1 emitted from the image display unit 10 is reflected by the beam splitter 30 and thereafter undergoes specular reflection at the retroreflecting surface 60a and thereby forms an optical path of the stray light entering the eyes of the observer 90. In this case, the observer 90 visually recognizes a virtual image at a position to the rear of the housing 80 as a position plane-symmetrical with the floating image A with respect to the retroreflecting surface 60a as a mirror surface.

Further, there is a case where the stray light is caused by diffraction occurring when the image light L1 passes through the apertures 50, for example. In this case, the stray light is slit-like diffracted light. When the image light L1 emitted from the image display unit 10 passes through the aperture 50, the image light L1 has broadening corresponding to the width of the aperture 50. The broadening of the diffracted light caused by the passage through the aperture 50 increases with the decrease in the width of the aperture 50. Further, the broadening of the diffracted light from an ideal image formation position of light increases depending on the travel distance of the light after the occurrence of the diffraction (in other words, an “optical path length”). Thus, if the diffracted light travels in the optical path for forming the floating image A, the diffracted light forms an image at a position different from the ideal image formation position depending on the width of the aperture 50 and the optical path length. Accordingly, light gradations occur around image information that should be viewed as the floating image A and the visibility of the floating image A deteriorates.

Furthermore, the stray light is caused also by diffraction occurring when the image light L1 is incident upon the retroreflective element 60, for example. This is because the retroreflective element 60 has the retroreflecting surface 60a having a certain width in the X-axis direction similarly to the aperture 50. Here, in regard to the retroreflecting surface 60a, the size of the width necessary for retroreflecting the light incident thereon (the light L2 shown in FIG. 1) varies depending on the incidence angle of the light. Therefore, the width of the retroreflecting surface 60a taking part in the broadening of light caused by diffraction varies depending on the incidence angle of the light L2 with respect to the retroreflective element 60.

Moreover, the stray light is caused also by reflection of light multiple times between the beam splitter 30 and the retroreflective element 60, for example. Specifically, in the image formation optical system 70, there are cases where the light retroreflected by the retroreflective element 60 is reflected by the beam splitter 30 without passing through the beam splitter 30 and is then incident upon the retroreflective element 60 again. Light passing through the beam splitter 30 and entering the eyes of the observer 90 after being repeatedly reflected between the beam splitter 30 and the retroreflective element 60 forms an image at a position different from the ideal image formation position. In this case, the observer 90 might visually recognize unnecessary image information. It should be noted that luminance of the stray light entering the eyes of the observer 90 due to the repeated reflection between the beam splitter 30 and the retroreflective element 60 decreases depending on the reflectance of the beam splitter 30 or retroreflectivity of the retroreflective element 60. Therefore, the observer 90 becomes more likely to visually recognize the stray light with the increase in the luminance of the image 11 displayed on the image display unit 10.

Further, the stray light is light directly entering the eyes of the observer 90 without being reflected by the beam splitter 30, for example. For example, there is a case where the image light L1 emitted from the image display unit 10 passes through the apertures 50 of the retroreflective member 20 and thereafter directly enters the eyes of the observer 90 by passing through the beam splitter 30 without being reflected. In the first embodiment, the image light L1 directly entering the eyes of the observer 90 and the light 14 forming the floating image A are visually recognized at short distances from the observer 90. In this case, the visibility of the floating image A deteriorates. The deterioration of the visibility becomes more and more remarkable as the distance between the image display unit 10 and the floating image A becomes narrower due to the downsizing of the housing 80 of the floating image display device 100.

It should be noted that while the above-described stray light has been explained in regard to examples in which the stray light occurs based on the image light L1 emitted from the image display unit 10, the stray light is not limited to these examples. In some cases, depending on the environment around the place where the floating image display device 100 is installed, external light such as illuminating light or sunlight enters the inside of the housing 80 and is thereby visually recognized as the stray light, for example.

In the first embodiment, in order to prevent the deterioration of the visibility of the floating image A due to the above-described stray light, the retroreflective member 20 is configured so that the directions of the plurality of retroreflecting surfaces 61a to 65a differ from each other.

### Directions of the Plurality of Retroreflecting Surfaces 61a to 65a

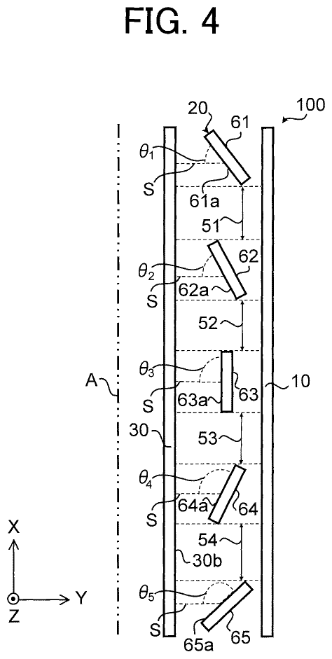

FIG. 4 is an explanatory drawing for explaining the configuration in which the directions of the plurality of retroreflecting surfaces 61a to 65a differ from each other. As shown in FIG. 4, in the first embodiment, the directions of the plurality of retroreflecting surfaces 61a to 65a differ from each other. In FIG. 4, a surface extending in the depth direction of the floating image display device 100, namely, a surface spreading in the X-axis direction and the Z-axis direction, is defined as a reference surface S. The angle θ₁, θ₂, θ₃, θ₄, θ₅ formed by the reference surface S and each of the retroreflecting surfaces 61a to 65a is an arrangement angle of each of the retroreflective elements 61 to 65. In the example shown in FIG. 4, the angles θ₁, θ₂, θ₃, θ₄ and θ₅ differ from each other. This arrangement makes the stray light unlikely to travel in the optical path of the light for forming the floating image A.

For example, in the case where the stray light is caused by the specular reflection at the retroreflecting surfaces 61a to 65a, there is a danger that the observer 90 visually recognizes the stray light depending on the directions of the retroreflecting surfaces 61a to 65a. Therefore, the deterioration of the visibility of the floating image A can be inhibited by setting the directions of the retroreflecting surfaces 61a to 65a so that the observer 90 does not visually recognize the stray light.

Further, when there exist a plurality of observers 90 viewing the floating image A, the directions of the retroreflecting surfaces 61a to 65a are set so that the plurality of observers 90 do not visually recognize the stray light. For example, when the directions of the retroreflecting surfaces 61a to 65a are parallel to the light splitting surface 30b, the observers 90 are likely to visually recognize the stray light caused by the specular reflection at the retroreflecting surfaces 61a to 65a. Therefore, the deterioration of the visibility of the floating image A can be inhibited by arranging part of the plurality of retroreflecting surfaces 61a to 65a (the retroreflecting surfaces 61a, 62a, 64a and 65a in the example shown in FIG. 4) to be not parallel to the light splitting surface 30b. It should be noted that it is permissible if at least one retroreflecting surface of the plurality of retroreflecting surfaces 61a to 65a is not parallel to the light. splitting surface 30b.

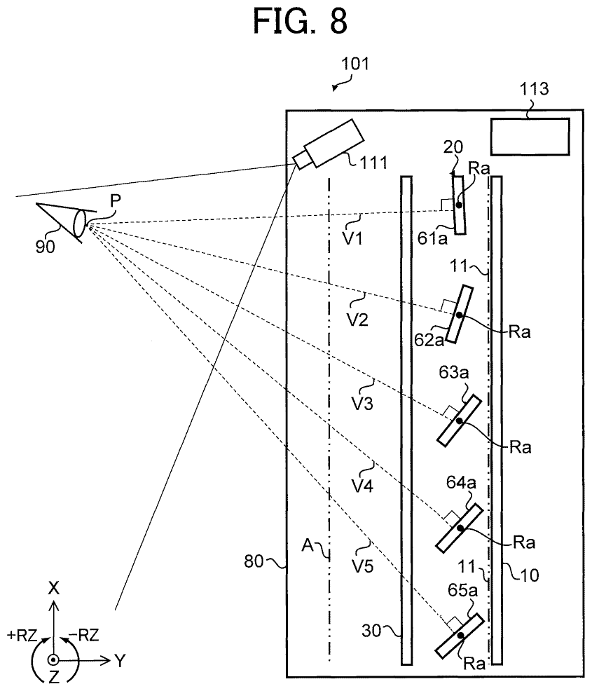

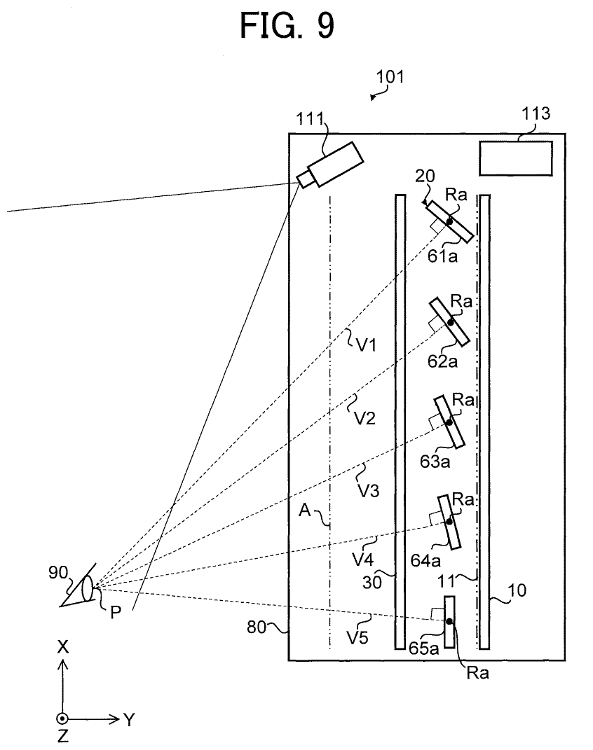

In the case where the stray light is diffracted light caused by the diffraction occurring at the time of passing through the apertures 50, the occurrence of the light gradations around the floating image A can be inhibited by setting the directions of the retroreflecting surfaces 61a to 65a. Specifically, magnitude of influence of diffraction is determined by the width of the aperture 50 (hereinafter referred to also as an “aperture width”), and the influence of diffraction decreases with the increase in the aperture width. Therefore, the influence of diffraction can be reduced to a minimum by setting the directions of the plurality of retroreflecting surfaces 61a to 65a so that the observer 90 is situated in a normal direction of each of the plurality of retroreflecting surfaces 61a to 65a. This is because the widths of two adjacent apertures 50 widen when the eyes of the observer 90 exist on a normal line of each of the plurality of retroreflecting surfaces 61a to 65a (e.g., normal line V1-V5 shown in FIGS. 8 and 9 which will be explained later).

Further, in the case where the stray light is diffracted light caused at the time of passing through the apertures 50, the mode of the broadening of light and the mode of the broadening of light in regard to each color of light change. Suppose that the diffracted light has occurred in a configuration in which the directions of the plurality of retroreflecting surfaces 61a to 65a are the same, the observer 90 visually recognizes that pattern light has occurred. Therefore, by making the directions of the plurality of retroreflecting surfaces 61a to 65a differ from each other, i.e., by configuring the retroreflective member 20 in which the arrangement angles of the retroreflective elements 61 to 65 are nonuniform, the widths of the plurality of apertures 50 are made different from each other and thus invisualization of the pattern light can be achieved.

In the case where the stray light is caused by reflection of light multiple times between the beam splitter 30 and the retroreflective elements 61 to 65, a region in which the observer 90 visually recognizes the stray light can be minimized by making the directions of the plurality of retroreflecting surfaces 61a to 65a differ from each other. In the example shown in FIG. 4, the reflection direction of light between the beam splitter 30 and the retroreflecting surface 61a and the reflection direction of light between the beam splitter 30 and the retroreflecting surface 62a differ from each other. With this configuration, it is possible to prevent the observer 90 from visually recognizing that the whole of the beam splitter 30 is shining due to the stray light. Accordingly, the visibility of the floating image A can be increased.

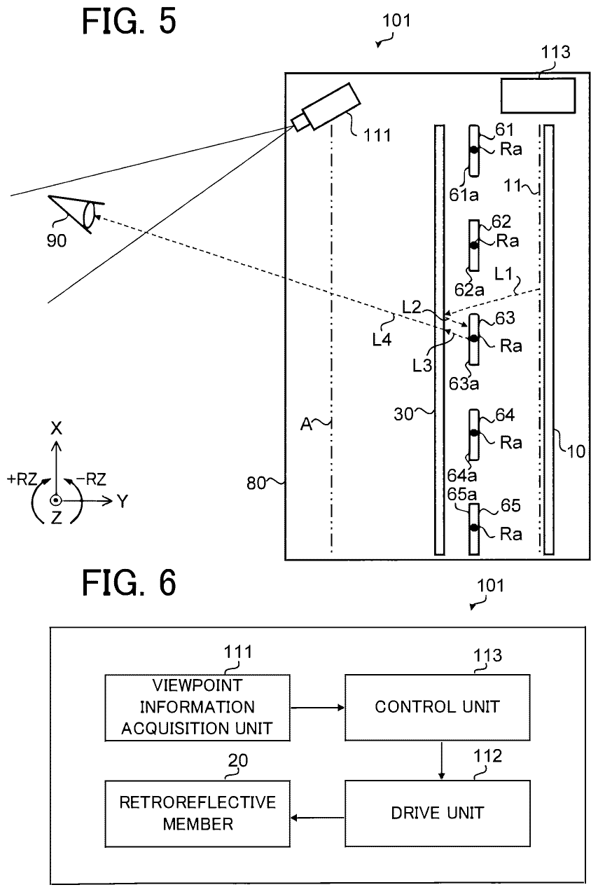

It should be noted that if the directions of the retroreflecting surfaces 61a to 65a as viewed from the observer 90 are parallel to the light splitting surface 30b, retroreflection accuracy is low and the visibility of the floating image A deteriorates. Therefore, it is preferable that the retroreflecting surface 60a be inclined with respect to the reference surface S by an angle less than or equal to 45° towards the beam splitter 30's side or the image display unit 10's side. Further, in the case where the shape of the aperture 50 is a slit-like shape, one example of the method of setting the directions of the plurality of retroreflecting surfaces 61a to 65a can be realized if the support parts 25 shown in FIG. 2 rotatably support the plurality of retroreflecting surfaces 61a to 65a. Specifically, the support parts 25 support the plurality of retroreflecting surfaces 61a to 65a so that each of the plurality of retroreflecting surfaces 61a to 65a is rotatable around an axis extending in the Z-axis direction (rotation axis Ra shown in FIG. 5 which will be explained later).

### Effect of First Embodiment

According to the above-described first embodiment, the directions of the plurality of retroreflecting surfaces 61a to 65a differ from each other. With this configuration, it is possible to prevent the observer 90 from visually recognizing the stray light in the case where the stray light is caused by the specular reflection at the retroreflecting surfaces 61a to 65a, for example. Accordingly, the floating image display device 100 is capable of inhibiting the deterioration of the visibility of the floating image A.

Further, according to the first embodiment, the direction of at least one retroreflecting surface of the plurality of retroreflecting surfaces 61a to 65a is not parallel to the light splitting surface 30b. With this configuration, the observer 90 becomes unlikely to visually recognize the stray light caused by the specular reflection at the retroreflecting surfaces 61a to 658, for example. Accordingly, the floating image display device 100 is capable of further inhibiting the deterioration of the visibility of the floating image A.

Furthermore, according to the first embodiment, the plurality of retroreflecting surfaces 61a to 65a are arranged at positions facing the light splitting surface 30b of the beam splitter 30 in the Y-axis direction orthogonal to the array direction of the plurality of apertures 51 to 54. By this arrangement, the floating image display device 100 can be downsized.

### Modification of First Embodiment

FIG. 5 is a diagram schematically showing an example of the configuration of a floating image display device 101 according to a modification of the first embodiment. FIG. 6 is a block diagram showing the configuration of the floating image display device 101 according to the modification of the first embodiment. In FIGS. 5 and 6, each component identical or corresponding to a component shown in FIG. 1 is assigned the same reference character as in FIG. 1. The floating image display device 101 according to the modification of the first embodiment differs from the floating image display device 100 according to the first embodiment in further including a viewpoint information acquisition unit 111, a drive unit 112 and a control unit 113. Except for these features, the floating image display device 101 according to the modification of the first embodiment is the same as the floating image display device 100 according to the first embodiment.

As shown in FIGS. 5 and 6, the floating image display device 101 includes the image display unit 10, the beam splitter 30, the retroreflective member 20, the viewpoint information acquisition unit 111, the drive unit 112 and the control unit 113. It should be noted that, in the modification of the first embodiment, the optical path of the light for forming the floating image A is the same as that in the first embodiment, and thus repeated description thereof is left out.

The viewpoint information acquisition unit 111 acquires viewpoint information indicating the position of the eyes of the observer 90. The viewpoint information acquisition unit 111 is, for example, an image capturing device such as a camera. The viewpoint information acquisition unit 111 is, for example, a device that detects an object existing in the three-dimensional space by using infrared pattern light. The viewpoint information acquisition unit 111 can also be a three-dimensional measurement device that measures the distance to an object based on a time (referred to also as a “reflection time”) from an infrared irradiation starting time point to a light reception time point of infrared returning light reflected by the object. With such a device, the position of the viewpoint of the observer 90 in the space can be detected.

Further, in the case where the viewpoint information acquisition unit 111 is a two-dimensional image capturing device that detects visible light, the viewpoint information acquisition unit 111 is capable of measuring the three-dimensional positional relationship of the observer 90 with the floating image display device 101 by estimating the position of a mobile object (e.g., the eyes of the observer 90) in a three-dimensional space coordinate system by use of an optical flow. In the case where the viewpoint information acquisition unit 111 is formed with a plurality of two-dimensional image capturing devices, the viewpoint information acquisition unit 111 is capable of measuring the position of the observer 90 with respect to the floating image display device 101 based on a three-dimensional distance obtained by triangulation. It should be noted that the viewpoint information acquisition unit 111 is not limited to an image capturing device but can also be a beacon instrument or the like that outputs the position of the observer 90. For example, if the observer 90 carries a beacon instrument that receives radio waves propagating in the space, the viewpoint information regarding the observer 90 can be acquired based on the position of the beacon instrument with respect to the floating image display device 101. Further, the viewpoint information acquisition unit 111 can also be a device that acquires spatial position information such as a GPS (Global Positioning System) included in a device carried by the observer 90.

The drive unit 112 drives the plurality of retroreflective elements 61 to 65. The drive unit 112 is a motor, for example. In the example shown in FIG. 5, each of the plurality of retroreflective elements 61 to 65 rotates around the rotation axis Ra extending in the Z-axis direction, for example. In FIG. 5 and in FIGS. 8 and 9 which will be explained later, a +RZ direction is a clockwise direction when facing the +Z-axis direction, and a-RZ direction is a counterclockwise direction as a direction reverse to the +RZ direction.

The control unit 113 controls the drive unit 112 based on the viewpoint information acquired by the viewpoint information acquisition unit 111. The control unit 113 commands the drive unit 112 to make the directions of the plurality of retroreflecting surfaces 61a to 65a differ from each other based on the viewpoint information.

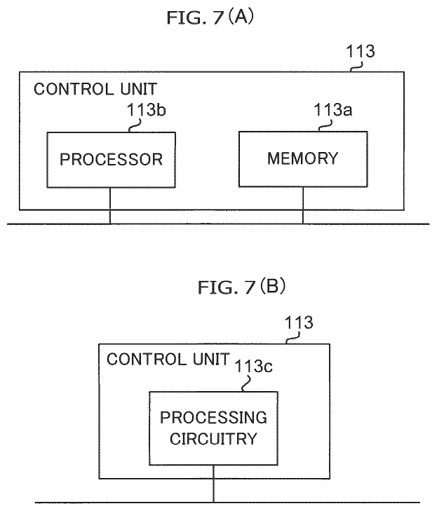

FIG. 7(A) is a diagram schematically showing an example of the hardware configuration of the control unit 113 of the floating image display device 101. As shown in FIG. 7(A), the control unit 113 of the floating image display device 101 can be implemented, for example, by using a memory 113a as a storage device that stores a program as software and a processor 113b as an information processing unit that implements the program stored in the memory 113a (e.g., by a computer). It should be noted that it is permissible even if part of the control unit 113 is implemented by the memory 1138 shown in FIG. 7(A) and the processor 113b executing a program. Further, the control unit 113 may also be implemented by an electric circuit.

FIG. 7(B) is a diagram schematically showing another example of the hardware configuration of the control unit 113 of the floating image display device 101. As shown in FIG. 7(B), the control unit 113 may be implemented by using processing circuitry 113c as dedicated hardware such as a single circuit or a combined circuit. In this case, the functions of the control unit 113 are implemented by the processing circuitry. In the following, a description will be given of an example of controlling the directions of the plurality of retroreflecting surfaces 61a to 65a based on the viewpoint information regarding the observer 90.

FIG. 8 is an explanatory drawing for explaining an example of the control of the directions of the plurality of retroreflecting surfaces 61a to 65a in the floating image display device 101 according to the modification of the first embodiment. FIG. 9 is an explanatory drawing for explaining another example of the control of the directions of the plurality of retroreflecting surfaces 61a to 65a in the floating image display device 101 according to the modification of the first embodiment. In FIGS. 8 and 9, the position of the observer 90 in the space, that is, the line of sight of the observer with respect to the floating image A, differs from each other.

The control unit 113 controls the drive unit 112 so that the plurality of retroreflecting surfaces 61a to 65a face a reference position P set as the position of the viewpoint of the observer 90. Specifically, the control unit 113 makes the drive unit 112 set the directions of the plurality of retroreflecting surfaces 61a to 65a so that the eyes of the observer 90 exist on the normal line V1-V5 of each of the plurality of retroreflecting surfaces 61a to 65a. By this control, the width between two apertures 50 adjacent to each other in the X-axis direction widens, and thus the influence of the stray light caused by the diffraction occurring at the time of passing through the apertures 50 can be reduced to a minimum and the occurrence of the gradations appearing around the floating image A can be inhibited.

Further, since the control unit 113 controls the directions of the plurality of retroreflecting surfaces 61a to 65a based on the viewpoint information, the stray light caused by the specular reflection at the retroreflecting surfaces 61a to 65a can be inhibited from traveling in the optical path for forming the floating image A. In other words, overlap of a specular reflection image and the floating image A can be prevented. Accordingly, the floating image display device 101 is capable of inhibiting the deterioration of the observer 90's visibility of the floating image A.

Here, the directions of the retroreflecting surfaces 61a to 65a minimizing the influence of the diffracted light are uniquely determined by the position of the observer 90. In the modification of the first embodiment, the drive unit 112 continuously changes the directions of the plurality of retroreflecting surfaces 61a to 65a per unit time. Accordingly, when there exist a plurality of observers 90, the influence of the diffracted light visually recognized by each of the plurality of observers 90 can be smoothed, and the deterioration of the visibility of the floating image A can be inhibited.

Further, suppose that the directions of the plurality of retroreflecting surfaces 61a to 65a per unit time change uniformly, the observer 90 might visually recognize the diffracted light as being pattern light. In the modification of the first embodiment, the observer 90 can be inhibited from visually recognizing the pattern light by continuously (i.e., dynamically) changing the directions of the plurality of retroreflecting surfaces 61a to 65a per unit time so that they become nonuniform.

### Effect of Modification of First Embodiment

According to the above-described modification of the first embodiment, the control unit 113 controls the drive unit 112, which rotates each of the plurality of retroreflecting surfaces 61a to 65a around the rotation axis Ra, based on the viewpoint information regarding the observer 90. Specifically, the control unit 113 controls the drive unit 112 so that the plurality of retroreflecting surfaces 61a to 65a face the reference position P set as the position of the viewpoint of the observer 90. By this control, the stray light caused by the specular reflection at the retroreflecting surfaces 61a to 65a can be inhibited from traveling in the optical path for forming the floating image A, for example. Accordingly, the floating image display device 101 is capable of inhibiting the deterioration of the visibility of the floating image A.

### Second Embodiment

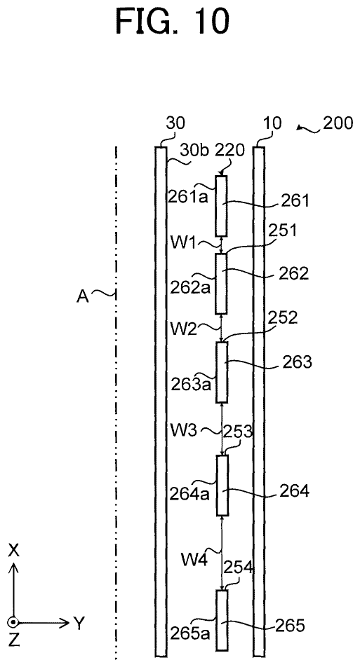

FIG. 10 is a configuration diagram schematically showing an example of the configuration of a floating image display device 200 according to a second embodiment. In FIG. 10, each component identical or corresponding to a component shown in FIG. 1 is assigned the same reference character as in FIG. 1. The floating image display device 200 according to the second embodiment differs from the floating image display device 100 according to the first embodiment in inhibiting the deterioration of the visibility of the floating image A by making widths W1, W2, W3 and W4 of a plurality of apertures 251, 252, 253 and 254 differ from each other. Except for this feature, the floating image display device 200 according to the second embodiment is the same as the floating image display device 100 according to the first embodiment. Thus, FIG. 1 is referred to in the following description.

As shown in FIG. 10, the floating image display device 200 includes the image display unit 10, a retroreflective member 220 and the beam splitter 30. It should be noted that illustration of the housing 80 (see FIG. 1) is left out in the example shown in FIG. 10.

The retroreflective member 220 includes the plurality of apertures 251 to 254 and a plurality of retroreflective elements 261, 262, 263, 264 and 265. It should be noted that, in the following description, the retroreflective member 220 is referred to also as a “first retroreflective member 220”.

The image light L1 (see FIG. 1) emitted from the image display unit 10 passes through the plurality of apertures 251 to 254. The shape of each of the plurality of apertures 251 to 254 is a slit-like shape being long in the Z-axis direction, The plurality of retroreflective elements 261 to 265 retroreflect light incident thereon. The plurality of retroreflective elements 261 to 265 respectively have a plurality of retroreflecting surfaces 261a to 265a as a plurality of first retroreflecting surfaces. The plurality of retroreflecting surfaces 261a to 265a are arranged at positions facing the light splitting surface 30b of the beam splitter 30 (see FIG. 1) in the Y-axis direction orthogonal to the array direction of the plurality of apertures 251 to 254 (i.e., the X-axis direction). It should be noted that, in the following description, the plurality of retroreflective elements 261 to 265 are also collectively referred to as “the plurality of retroreflective elements 260” when it is unnecessary to distinguish among the plurality of retroreflective elements 261 to 265. Further, the plurality of retroreflecting surfaces 261a to 265a are also collectively referred to as “the plurality of retroreflecting surfaces 260a” when it is unnecessary to distinguish among the plurality of retroreflecting surfaces 261a to 265a.

In the second embodiment, the widths W1 to W4 of the plurality of apertures 251 to 254 differ from each other. With this configuration, the influence of the diffracted light caused by the diffraction occurring when the image light L1 (see FIG. 1) passes through the apertures 251 to 254 can be reduced. In general, the broadening of light due to diffraction increases with the decrease in the width of the aperture. Therefore, the light amount of the stray light (i.e., diffracted light) appearing around the floating image A can be reduced by setting the widths of apertures used for the optical path of the light for forming the floating image A (in FIG. 10, the widths W3 and W4 of the apertures 253 and 254) to be wider than the widths of the other apertures (in FIG. 10, the widths W1 and W2 of the apertures 251 and 252).

Further, the magnitude of the influence of the diffracted light on the floating image A is dependent also on the aperture width in a direction (i.e., the X-axis direction) orthogonal to a ray direction of light heading for the eyes of the observer 90. Put another way, suppose that the widths W1 to W4 of the plurality of apertures 251 to 254 are the same, as an angle at which the observer 90 views the floating image display device 200 becomes closer to the right angle, the broadening of light passing through the apertures 251 to 254 increases and the observer 90 viewing the floating image A becomes less likely to be influenced by the diffracted light. In contrast, as the angle at which the observer 90 views the floating image display device 200 becomes closer to a horizontal angle, the broadening of light passing through the apertures 251 to 254 decreases and the observer 90 viewing the floating image A is more likely to be influenced by the diffracted light. Therefore, the influence of the stray light on the floating image A can be reduced by making the widths W1 to W4 of the plurality of apertures 251 to 254 differ from each other based on the positional relationship between the observer 90 and the floating image display device 200.

Further, with the widths W1 to W4 of the plurality of apertures 251 to 254 differing from each other, the invisualization of the pattern light can be realized. It should be noted that if the widths of the apertures 251 to 254 are too wide, the amount of light traveling in the optical path for forming the floating image A in the image light L1 after passing through the apertures 251 to 254 decreases, and thus a maximum value of the widths of the apertures 251 to 254 is desired to be approximately twice the width of the retroreflecting surfaces 261a to 265a. Put another way, the widths of the apertures 251 to 254 are desired to be less than or equal to twice the width of the retroreflecting surfaces 261a to 265a.

Furthermore, the widths W1 to W4 of the plurality of apertures 251 to 254 differ from each other, which can prevent the image light L1 from being directly viewed by the eyes of the observer 90. Here, as the widths W1 to W4 of the apertures 251 to 254 increase, regions through which light included in the image light L1 and directly entering the eyes of the observer 90 (hereinafter referred to also as “direct light”) passes become larger. Therefore, the deterioration of the visibility of the floating image A can be inhibited by narrowing the widths W1 to W4 of the apertures 251 to 254 in the optical path for forming the floating image A so that the direct light is not visually recognized around a region where the floating image A is visually recognized by the observer 90.

It should be noted that the magnitude of the influence of the direct light on the floating image A is also dependent on the aperture width in the direction orthogonal to the ray direction of light heading for the eyes of the observer 90. Put another way, suppose that the widths Wi to W4 of the plurality of apertures 251 to 254 are the same, as the angle at which the observer 90 views the floating image display device 200 becomes closer to the vertical angle, the light amount of the direct light passing through the apertures 251 to 254 increases and the observer 90 viewing the floating image A is more likely to be influenced by the direct light. In contrast, as the angle at which the observer 90 views the floating image display device 200 becomes closer to the horizontal angle, the light amount of the direct light passing through the apertures 251 to 254 decreases and the observer 90 viewing the floating image A is less likely to be influenced by the direct light. Therefore, the influence of the direct light can be reduced by making the widths W1 to W4 of the plurality of apertures 251 to 254 differ from each other based on the positional relationship between the observer 90 and the floating image display device 200.

As mentioned earlier, in order to reduce the influence of the diffracted light on the floating image A, it is desirable to increase the widths W1 to W4 of the apertures 251 to 254. In this way, reducing the influence of the diffracted light and reducing the influence of the direct light are in the trade-off relationship. Therefore, it is necessary to set the widths W1 to W4 of the plurality of apertures 251 to 254 by judging which of the influence of the diffracted light and the influence of the direct light is greater based on the environment in which the floating image display device 200 is arranged and the position of the eyes of the observer 90.

In the first embodiment described earlier, the deterioration of the visibility of the floating image A due to the stray light can be inhibited if the arrangement angles of the retroreflecting surfaces 61a to 65a are less than or equal to 45°. Further, in the retroreflective member 220, if the widths W1 to W4 of the apertures 251 to 254 are less than or equal to approximately twice the width of the retroreflecting surfaces 261a to 265a, the deterioration of the visibility of the floating image A due to the stray light can be inhibited. It should be noted that the floating image display devices 100 and 200 according to the first and second embodiments are widely applicable to various image display devices from small-sized image display devices used in financial institutions and the like to large-sized image display devices placed outdoors, for example. Thus, the widths of the apertures 251 to 254 and the arrangement angles of the retroreflecting surfaces 261a to 265a may be properly modified depending on the purpose of the floating image display device 100, 200. For example, when the floating image display device 100, 200 is large-sized, the widths W1 to W4 of the apertures 251 to 254 and the arrangement angles of the retroreflecting surfaces 261a to 265a may exceed the aforementioned ranges.

### Effect of Second Embodiment

According to the above-described second embodiment, the widths W1 to W4 of the plurality of apertures 251 to 254 differ from each other. With this configuration, the observer 90 becomes unlikely to visually recognize the pattern light due to diffraction, for example. Accordingly, the floating image display device 200 is capable of inhibiting the deterioration of the visibility of the floating image A.

### First Modification of Second Embodiment

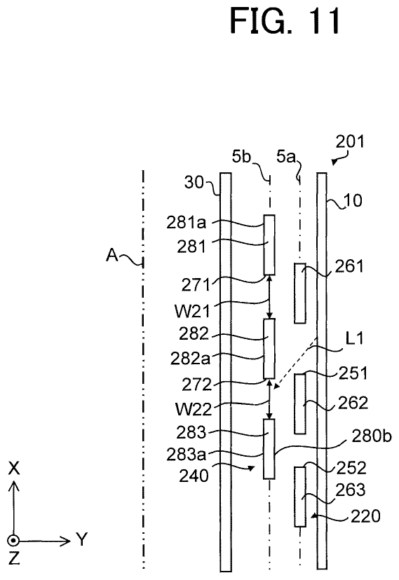

FIG. 11 is a configuration diagram schematically showing an example of the configuration of a floating image display device 201 according to a first modification of the second embodiment.

In FIG. 11, each component identical or corresponding to a component shown in FIG. 10 is assigned the same reference character as in FIG. 10. The floating image display device 201 according to the first modification of the second embodiment differs from the floating image display device 200 according to the second embodiment in further including a second retroreflective member 240. Except for this feature, the floating image display device 201 according to the first modification of the second embodiment is the same as the floating image display device 200 according to the second embodiment.

As shown in FIG. 11, the floating image display device 201 includes the image display unit 10, the first retroreflective member 220, the beam splitter 30 and the second retroreflective member 240.

The second retroreflective member 240 is arranged on the beam splitter 30's side from the first retroreflective member 220. The second retroreflective member 240 is arranged at a position facing the first retroreflective member 220. In other words, the second retroreflective member 240 is arranged side by side with the first retroreflective member 230 in the Y-axis direction as the depth direction.

The second retroreflective member 240 includes a plurality of second apertures 271 and 272 and a plurality of second retroreflective elements 281, 282 and 283. It should be noted that, in the following description, the plurality of second retroreflective elements 281, 282 and 283 are also collectively referred to as “second retroreflective elements 280” when it is unnecessary to distinguish among the plurality of second retroreflective elements 281, 282 and 283.

The image light Li passing through the plurality of first apertures 251 and 252 and heading for the beam splitter 30 passes through the plurality of second apertures 271 and 272. Widths W21 and W22 of the plurality of second apertures 271 and 272 differ from each other.

The plurality of second retroreflective elements 281, 282 and 283 respectively have a plurality of second retroreflecting surfaces 281a, 282a and 283a. The plurality of second retroreflective elements 281, 282 and 283 respectively face a plurality of first retroreflective elements 261, 262 and 263. In the example shown in FIG. 11, the plurality of second retroreflective elements 281, 282 and 283 respectively face parts of the plurality of first retroreflective elements 261, 262 and 263. As above, the floating image display device 201 includes the retroreflective elements 260 in a first line Sa arrayed in the X-axis direction and the second retroreflective elements 280 in a second line 5b arrayed in the X-axis direction. The second retroreflective elements 280 are arrayed to be shifted in the X-axis direction relative to the adjacent first retroreflective elements 260. Therefore, in the example shown in FIG. 11, the plurality of second retroreflective elements 282 and 283 respectively face the plurality of first apertures 251 and 252.

The image light L1 emitted from the image display unit 10 passes through the first apertures 251 and 252 and the second apertures 271 and 272. In this case, the image light L1 travels in a state of being inclined with respect to the Y-axis direction towards the +X-axis side (or the-X-axis side). As above, in the first modification of the second embodiment, the image light L1 traveling in the state of being inclined with respect to the Y-axis direction is made to form an image as the floating image A. Thus, the visibility can be increased when the observer 90 views the floating image A in an oblique direction.

Further, in the example shown in FIG. 11, the image light L1 emitted from the image display unit 10 can be inhibited from directly entering the eyes of the observer 90 without being reflected by the beam splitter 30. This is because the direct light included in the image light L1 emitted from the image display unit 10 is blocked by back surfaces 280b of the second retroreflective elements 280.

Furthermore, in the example shown in FIG. 11, the deterioration of the visibility of the floating image A due to the diffracted light occurring at the time of passing through the first apertures 251 and 252 can be inhibited since the second retroreflective elements 280 are arranged to be shifted in the X-axis direction relative to the adjacent first retroreflective elements 260. Here, the broadening of the diffracted light increases with the increase in the optical path length until the diffracted light forms the image. Therefore, the size of the stray light broadening around the floating image A varies depending on the arrangement relationship between the first retroreflective elements 260 and the second retroreflective elements 280. In the first modification of the second embodiment, the second retroreflective elements 280 are arranged to be shifted in the X-axis direction relative to the adjacent first retroreflective elements 260. By this arrangement, the invisualization of the pattern light can be realized and the deterioration of the visibility of the floating image A can be inhibited.

### Effect of First Modification of Second Embodiment

According to the above-described first modification of the second embodiment, the floating image display device 201 further includes the second retroreflective member 240 including the plurality of second apertures 271 and 272 and the plurality of second retroreflective elements 280, and the plurality of second retroreflective elements 280 are arranged to be shifted in the X-axis direction relative to the adjacent first retroreflective elements 260. With this configuration, the occurrence of the pattern light when the observer 90 views the floating image A can be inhibited. Accordingly, the floating image display device 201 is capable of inhibiting the deterioration of the visibility of the floating image A.

### Second Modification of Second Embodiment

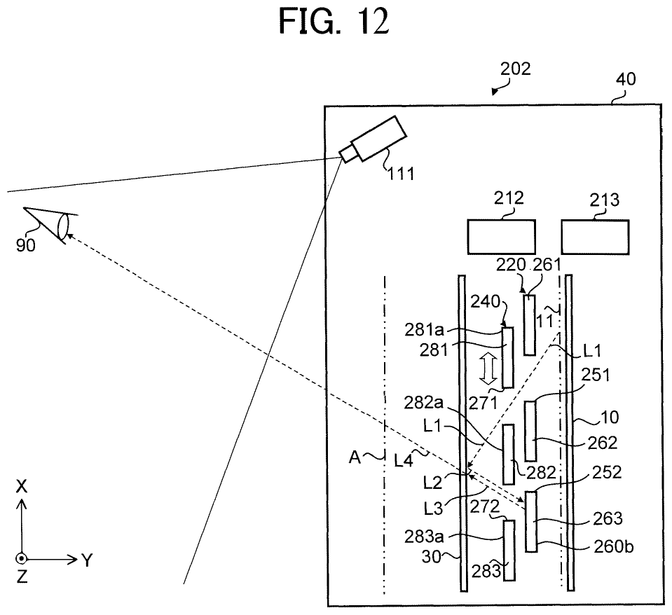

FIG. 12 is a configuration diagram schematically showing an example of the configuration of a floating image display device 202 according to a second modification of the second embodiment. In FIG. 12, each component identical or corresponding to a component shown in FIG. 6 or 11 is assigned the same reference character as in FIG. 6 or 11. The floating image display device 202 according to the second modification of the second embodiment differs from the floating image display device 201 according to the first modification of the second embodiment in further including the viewpoint information acquisition unit 111, a drive unit 212 and a control unit 213. Except for these features, the floating image display device 202 according to the second modification of the second embodiment is the same as the floating image display device 201 according to the first modification of the second embodiment.

As shown in FIG. 12, the floating image display device 202 includes the image display unit 10, the first retroreflective member 220, the beam splitter 30, the second retroreflective member 240, the viewpoint information acquisition unit 111, the drive unit 212 and the control unit 213.

The drive unit 212 translates the plurality of second retroreflecting surfaces 281a, 282a and 283a in the X-axis direction as the array direction of the plurality of the plurality of second apertures 271 and 272. In the example shown in FIG. 12, the plurality of first retroreflective elements 261, 262 and 263 are fixed.

The control unit 213 controls the drive unit 212 based on the viewpoint information acquired by the viewpoint information acquisition unit 111. Specifically, the control unit 213 controls the drive unit 212 so that the light for forming the floating image A passes through the first apertures 251 and 252 and the second apertures 271 and 272. The hardware configuration of the control unit 213 is the same as that in FIG. 7(A) or 7(B) explained earlier, and thus repeated description thereof is left out.

In the second modification of the second embodiment, the stray light is blocked by back surfaces 260b of the first retroreflective elements 260. Therefore, the image light L1 emitted from the image display unit 10 can be prevented from directly entering the eyes of the observer 90 without being reflected by the beam splitter 30. Further, light specularly reflected by the retroreflecting surface of the first retroreflective element 260 is blocked by the back surface 280b of the second retroreflective element 280. Accordingly, the floating image display device 202 is capable of inhibiting the deterioration of the visibility of the floating image A.

### Effect of Second Modification of Second Embodiment

According to the above-described second modification of the second embodiment, the floating image display device 202 includes the viewpoint information acquisition unit 111, the drive unit 212 that translates the second retroreflecting surfaces 281a, 282a and 283a, and the control unit 213 that controls the drive unit 212 based on the viewpoint information. With this configuration, it is possible to allow only the light for forming the floating image A to pass through the first apertures 251 and 252 and the second apertures 271 and 272. Put another way, the stray light can be inhibited from traveling in the optical path of the light for forming the floating image A. Accordingly, the floating image display device 202 is capable of inhibiting the deterioration of the visibility of the floating image A.

### Third Embodiment

FIG. 13 is a perspective view showing the configuration of a retroreflective member of a floating image display device according to a third embodiment. The floating image display device according to the third embodiment differs from the floating image display device 100, 200 according to the first or second embodiment in that a retroreflective sheet 321 as the retroreflective member has a single retroreflecting surface 361. Except for this feature, the floating image display device 300 according to the third embodiment is the same as the floating image display device 100, 200 according to the first or second embodiment. Thus, FIG. 1 is referred to in the following description.

As shown in FIG. 13, the retroreflective sheet 321 in the third embodiment includes a plurality of apertures 351 and 352 and the single retroreflecting surface 361. It should be noted that, in the following description, the retroreflective sheet 321 is referred to also as a “first retroreflective sheet 321”, and the plurality of apertures 351 and 352 are referred to also as “the plurality of first apertures 351 and 352”.

The image light L1 (see FIG. 1) emitted from the image display unit 10 passes through the plurality of apertures 351 and 352. The shape of each of the plurality of apertures 351 and 352 is, for example, a rectangular shape extending in the X-axis direction and the Y-axis direction. It should be noted that the shape of each of the plurality of apertures 351 and 352 is not limited to the rectangular shape but can also be a different shape such as a circular shape.

Widths W11 and W12 of the plurality of apertures 351 and 352 in the X-axis direction differ from each other. With this configuration, the invisualization of the pattern light can be realized when the image light L1 passes through the plurality of apertures 351 and 352. Thus, the deterioration of the visibility of the floating image A (see FIG. 1) can be inhibited. In the example shown in FIG. 13, the width W12 of the aperture 352 is wider than the width Will of the aperture 351.

The plurality of apertures 351 and 352 are arrayed like a lattice, namely, like a matrix having a plurality of rows and a plurality of columns. The plurality of apertures 351 and 352 are formed by, for example, performing hole making processing on the retroreflecting surface 361. The plurality of apertures 351 and 352 are formed (shaped) by, for example, performing punching processing or laser processing on the retroreflecting surface 361.

### Modification

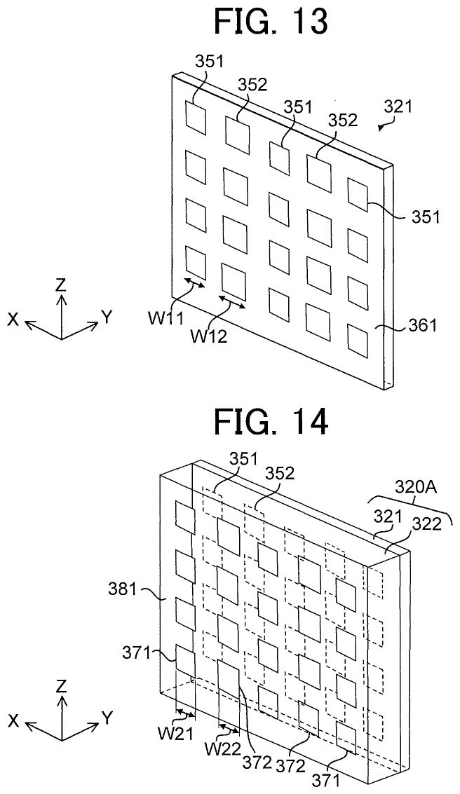

FIG. 14 is a perspective view showing the configuration of a retroreflective member 320A in a modification of the floating image display device according to the third embodiment. As shown in FIG. 14, the retroreflective member 320A may be formed with the first retroreflective sheet 321 and a second retroreflective sheet 322 stacked in the depth direction. The second retroreflective sheet 322 is arranged on the-Y-axis side (on the side of the beam splitter 30 shown in FIG. 1) relative to the first retroreflective sheet 321.

The second retroreflective sheet 322 includes a plurality of second apertures 371 and 372 and a single second retroreflecting surface 381. Widths W21 and W22 of the plurality of second apertures 371 and 372 in the X-axis direction differ from each other. In the example shown in FIG. 14, the width W22 of the second aperture 372 is wider than the width W21 of the second aperture 371.

The plurality of second apertures 371 and 372 are arrayed like a matrix having a plurality of rows and a plurality of columns. As the second retroreflective sheet 322 is viewed in the depth direction (Y-axis direction), the plurality of second apertures 371 overlap with the plurality of first apertures 351, and the plurality of second apertures 372 overlap with the plurality of first apertures 352. As above, the plurality of first apertures 351 and 352 arrayed like a matrix and the plurality of second apertures 371 and 372 arrayed like a matrix may be arranged to face each other. With this configuration, the diffracted light that occurs when the image light L1 passes through the first apertures 351 and 352 can be blocked by the second retroreflective sheet 322. Further, the direct light from the image display unit 10 can be blocked by the first retroreflective sheet 321. Accordingly, the deterioration of the visibility of the floating image A is inhibited.

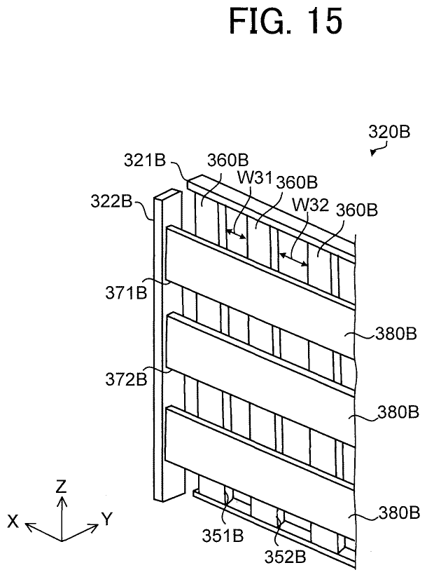

FIG. 15 is a perspective view showing another example of the configuration of a retroreflective member 320B in the modification of the floating image display device according to the third embodiment. As shown in FIG. 15, the retroreflective member 320B includes a first retroreflective sheet 321B and a second retroreflective sheet 322B.

The first retroreflective sheet 321B includes a plurality of first apertures 351B and 352B like slits being long in the Z-axis direction and a plurality of first retroreflecting surfaces 360B being long in the Z-axis direction. Widths W31 and W32 of the plurality of first apertures 351B and 352B differ from each other. The second retroreflective sheet 322B is arranged on the −Y-axis side (i.e., on the side of the beam splitter 30 shown in FIG. 1) from the first retroreflective sheet 321B. The second retroreflective sheet 322B includes a plurality of first apertures 371B and 372B like slits being long in the X-axis direction and a plurality of second retroreflecting surfaces 380B being long in the X-axis direction.

The plurality of second retroreflecting surfaces 380B extend in the X-axis direction so as to face the plurality of first retroreflecting surfaces 360B. By arranging the plurality of second retroreflecting surfaces 380B being long in the X-axis direction at positions facing the plurality of first retroreflecting surfaces 360B being long in the Z-axis direction as above, the retroreflective member 320B in which a plurality of apertures have been formed like a lattice can be implemented.

### Effect of Third Embodiment

According to the above-described third embodiment, the retroreflective sheet 321 as the retroreflective member includes the plurality of apertures 351 and 352 like a lattice formed in the single retroreflecting surface 361, and the widths W31 and W32 of the plurality of apertures 351 and 352 differ from each other. With this configuration, the observer 90 becomes unlikely to visually recognize the pattern light due to diffraction, for example. Accordingly, the floating image display device according to the third embodiment is capable of inhibiting the deterioration of the visibility of the floating image A.

### DESCRIPTION OF REFERENCE CHARACTERS

10: image display unit, 10a: display surface, 11: image, 20, 220, 320A, 320B, 321: retroreflective member, 25: support part, 30: beam splitter (optical member), 308: front surface, 30b: light splitting surface, 50-54: aperture, 60-65, 260 265: retroreflective element (first retroreflective element), 60a, 61a, 62a, 63a, 64a, 65a: retroreflecting surface, 60b, 260b, 280b: back surface, 70: image formation optical system, 80: housing, 90: observer, 100, 101, 200, 201, 202: floating image display device, 111: viewpoint information acquisition unit, 112, 212: drive unit, 113, 213: control unit, 113a: memory, 113b: processor, 113c: processing circuitry, 240: second retroreflective member, 251-254, 351B, 352B: first aperture, 271, 272, 371, 372, 371B, 372B: second aperture, 281 283: second retroreflective element, 321: first retroreflective sheet, 322: second retroreflective sheet, 321B: first retroreflective member, 322B: second retroreflective member, 361, 360B: first retroreflecting surface, 381, 380B: second retroreflecting surface, A: floating image, L1: image light, L2, L3, L4: light, P: reference position, Ra: axis, S: reference surface, W1-W4, W10-W12, W21, W22, W31, W32; width

1.-15. (canceled)

16. A floating image display device comprising:
an image display that displays an image;
a first retroreflective member including a plurality of first apertures through which image light emitted from the image display passes and a single or plurality of first retroreflecting surfaces;
an optical member including a light splitting surface reflecting and passing incident light, the optical member reflecting the image light after passing through the plurality of first apertures and directing the image light toward the single or plurality of first retroreflecting surfaces; and
a second retroreflective member including a plurality of second apertures through which the image light passing through the plurality of first apertures and heading for the optical member passes and a plurality of second retroreflecting surfaces respectively facing the plurality of first retroreflecting surfaces, wherein
the image light retroreflected by the single or plurality of first retroreflecting surfaces passes through the optical member,
widths of the plurality of first apertures differ from each other,
the single or plurality of first retroreflecting surfaces are a plurality of first retroreflecting surfaces,
a width of each of the plurality of first apertures is less than or equal to twice a width of each of the plurality of first retroreflecting surfaces, and
the second retroreflective member is arranged on the optical member's side from the first retroreflective member.

17. The floating image display device according to claim 16, further comprising:
a viewpoint information acquisition circuit that acquires viewpoint information indicating a position of eyes of an observer;
a motor that moves the plurality of second retroreflecting surfaces in an array direction of the plurality of second apertures; and
a control circuit that controls the motor based on the viewpoint information.

18. The floating image display device according to claim 16, wherein the plurality of first retroreflecting surfaces are arranged at positions facing the light splitting surface in a second direction orthogonal to a first direction as an array direction of the plurality of first apertures.

19. A floating image display device comprising:
an image display that displays an image;
a retroreflective member including a plurality of apertures through which image light emitted from the image display passes and a plurality of retroreflecting surfaces;
an optical member including a light splitting surface reflecting and passing incident light, the optical member reflecting the image light after passing through the plurality of apertures and directing the image light toward the plurality of retroreflecting surfaces;
a viewpoint information acquisition circuit that acquires viewpoint information indicating a position of eyes of an observer;
a motor that rotates each of the plurality of retroreflecting surfaces around an axis extending in the third direction; and
a control circuit that controls the motor based on the viewpoint information, wherein
the image light retroreflected by the plurality of retroreflecting surfaces passes through the optical member,
directions of the plurality of retroreflecting surfaces differ from each other,
the plurality of retroreflecting surfaces are arranged at positions facing the light splitting surface in a second direction orthogonal to a first direction as an array direction of the plurality of apertures, and
a shape of each of the plurality of apertures is a slit-like shape being long in a third direction orthogonal to the first direction and the second direction.

20. The floating image display device according to claim 19, wherein the control circuit controls the motor so that the plurality of retroreflecting surfaces face a reference position set as the position of the eyes of the observer.

21. The floating image display device according to claim 19, wherein at least one retroreflecting surface of the plurality of retroreflecting surfaces is not parallel to the light splitting surface.

22. The floating image display device according to claim 16, wherein widths of the plurality of apertures differ from each other.

23. A floating image display device comprising:
an image display that displays an image;
a first retroreflective member including a plurality of first apertures through which image light emitted from the image display passes and a single first retroreflecting surface;
an optical member including a light splitting surface reflecting and passing incident light, the optical member reflecting the image light after passing through the plurality of first apertures and directing the image light toward the single first retroreflecting surface; and
a second retroreflective member including a plurality of second apertures through which the image light passing through the plurality of first apertures and heading for the optical member passes and a second retroreflecting surface arranged at a position facing the single first retroreflecting surface, wherein
the image light retroreflected by the single first retroreflecting surface passes through the optical member,
widths of the plurality of first apertures differ from each other,
the plurality of first apertures are arrayed like a matrix, and
the plurality of second apertures are arrayed like a matrix so as to overlap with the plurality of first apertures.

24. The floating image display device according to claim 19, wherein widths of the plurality of apertures differ from each other.
